(19) United States
(12) Patent Application Publication
(10) Pub. No.: US 2007/0027809 A1
(43) Pub. Date: Feb. 1, 2007

(54) Method for signaling geographical constraints

(76) Inventor: Jukka Alve, Vantaa (FI)

Correspondence Address: MORGAN & FINNEGAN, L.L.P., 3 WORLD FINANCIAL CENTER, NEW YORK, NY, 10281-2101, US

(21) Appl. No.: 11/193,494

(22) Filed: Aug. 1, 2005

(51) Int. Cl. H04L 9/00

(52) U.S. Cl. 705/51

(57) ABSTRACT

A system for efficiently controlling the distribution of digital media content to a remote receiving device while preserving usage permissions and/or restrictions defined by the content provider. The distribution control method of the present invention includes a simplified URI (such as a website URL) along with the core content in the digital media delivered to the device. The device may then access an authorizing website in order to determine whether the device is in compliance with the rules and/or restrictions of the core content. If the device is in compliance, it may access the content. If the device fails the compliance test, provisions may be offered to an end user to put the device into a condition allowing access to the content.

### BACKGROUND OF INVENTION

1. Field of Invention

The present invention relates to digital content protection and digital rights management. More specifically, the present invention relates to a novel system for controlling the transmission of digital content to a remote, and possibly unidentified, device in an efficient manner, while still maintaining the property rights of the content owner.

2. Description of Prior Art

The growing availability of both stationary and portable digital devices in the global marketplace has created a surging demand for up-to-date information delivered directly to the consumer. In at least one effort to address this growing market, Digital Video Broadcasting (DVB) is being implemented worldwide to facilitate delivery of high quality digital video content through various outlets. The initial standard for terrestrial digital video broadcasting systems, DVB-T, was approved in 1995, and has been implemented in many countries worldwide.

Building on the success of this original benchmark, the proliferation of various handheld digital devices has spawned a robust interest in delivering similar digital video content to portable units. For example, DVB-H is an extension of the DVB-T standard that targets low-power mobile devices to receive digital programming. This handheld standard includes a major portion of old DVB-T standard with some modifications, and delivers content mainly utilizing IP over MPEG2 transport stream to mobile devices and handheld computers without having to utilize the cellular networks traditionally employed by these devices.

While the potential to deliver digital video content to a wide array of both “stationary” and “mobile” consumers fulfills a desired need in the marketplace, it has also bred some controversy. Digital information, unlike its analog predecessor, does not degrade over time or through copying. A digital file can be copied indefinitely, and each copy will inherit the exact same quality as the initial source. Therefore, content providers, such as the studios represented by Motion Picture Association of America, broadcasters of live events including concerts and sports, radio broadcasters, publishers of books and magazines, etc. seek to distribute their content in a fashion controlled by various usage rules that limit how the media is accessed and/or duplicated.

One limitation that is often employed to limit the distribution of content is the current location of the device receiving or rendering the content. Content providers often insist on being able to distribute content so that it is confined only to certain geographical areas. One example of this is the region coding system designed for DVDs, which allows movies to be released to different regions at different times. The same applies to digital TV broadcasting. Broadcasting rights are territorial by nature. The rights to broadcast content are typically sold on the basis of the size of the potential audience, and therefore the broadcast signals are to be confined to the area (e.g. country) in which the broadcaster has the right to broadcast. In some cases, such as certain sports events like football and baseball games, the broadcasting is blocked for the local area around the stadium to entice people to buy the ticket to the actual game instead of watching it on TV, requiring a black-out area in which the broadcast is not accessible.

As home networks and broadband Internet connectivity become widely deployed, it will become easier to transfer content files recorded from broadcasts to a different location, or to access the broadcast content from a different location by streaming it live over the Internet. Thus, the device that is rendering the content is not necessarily in the same location, or even in the same geographical area, as the device that received the broadcast. To the user this gives the benefit of being able to consume the content regardless of time and place, but from the content provider's perspective it increases the risk that the content will be used in an area where the usage is not allowed. This has prompted content providers to ask for technical solutions that prevent remote access altogether by confining the content to a local environment such as a single home network. However, this has the downside that remote access will be prevented also in the area in which consuming the content would otherwise be permissible.

Further complicating the issue is the fact that a geographical position or area can be expressed using a variety of different coding schemes. For some devices it is more natural to support one coding scheme over others. For instance, a DVB-H receiver might know the location in terms of the transmitter cell identifier included in the broadcast signal it is currently receiving, but the DVB-H cell identifier would be useless for a mobile phone that has no DVB-H receiver, even if it is equipped with a GPS device that would tell its absolute geographical coordinates—unless the mobile phone also stores a digital mapping between these two coding schemes. The digital maps needed for such interpreting and converting from any one geographical coding scheme to another would require substantial storage capacity, making this approach impractical for small handheld devices.

In view of the need to enforce rules protecting content based on geographic restrictions, the content providers have been hesitant to support remote access because enforcing usage restrictions is difficult. A handheld digital device capable of remote access may be anywhere at anytime, and the status quo does not provide an effective method for both determining this location and enforcing a rule and/or restriction based on this information. This problem is compounded by the myriad of available digital devices all operating using different communication, location and operating systems. What is needed is an efficient and effective way for controlling digital video content delivered to remotely located, possibly unidentified digital devices so that the current device condition may be obtained and rules and/or restrictions may be enforced in regard to the current device condition. Further, the enforcement of these rules and/or restrictions should be carried out in a manner that is not hostile to the end consumer, and may, if appropriate, offer options to put the receiving device into compliance so as to enable the digital video content to be accessed.

### SUMMARY OF INVENTION

The present invention consists of a method, apparatus, computer program and system for both efficiently and effectively controlling the distribution of digital content to a remotely located digital device. The distribution method of the present invention alleviates the burden of communicating all of the information related to usage rules and/or restrictions as part of the digital media signal. This information may include permitted or excluded geographic areas in a variety of different formats, temporal restrictions, identification related restrictions, copy restrictions, etc. Instead, a simplified URI (such as a website URL) is included along with the core digital content. The receiving device may utilize the URI to access an authorizing website from which usage rules and/or restrictions may be obtained. This information is used to determine whether the device is in a compliant condition and may access the core content.

In at least one embodiment of the invention, the website is accessed by a content provider and/or an intermediary party. These parties may configure the authorizing website with usage rules and/or restrictions related to a specific item of digital content (file or stream). The end user receives the digital content including the core content along with a URI indicating the address of an authorizing website. The receiving device then contacts the authorizing website to determine relevant permissions or exclusions. The authorizing website contains the rules and/or restrictions information in a variety of different formats, allowing each device to obtain usage constraints in a format compatible with that device. The receiving device then determines whether its current condition (e.g., position, time, user id, etc.) is an allowable state in view of the rules and/or restrictions for the content.

In another embodiment of the invention, it may be determined that the receiving device is not in a condition compliant with the rules and/or restrictions controlling the use of the core content. However, options may exist to allow the device to conform to these guidelines. These options may be available as actions to be performed on the receiving device, and may include, for example, allowing the user to subscribe (or upgrade the subscription) to a fee based service legally providing the content, or allowing the device to schedule a reminder or an automatic download of desired content after a viewing ban has expired (e.g., 30 minutes after the completion of a live concert, sporting event, etc.)

Further, the device, when communicating with the authorizing website, may simply submit its current condition information to an intelligent module within the website. This module may decode the current condition information of the device, and then determine whether the device is in compliance with the rules and/or restrictions of the core content. The authorizing website may then simply grant or deny the device access to the core content.

The reliance upon an external website as an authorizing agent introduces the possibility of an attack by a party with malicious intent. For example, a hacker could invade the authorizing website, or alter routing information and introduce a redirection command that sends devices to another website. The other website could authorize all devices for all core content, regardless of existing usage constraints and the current condition of the receiving device. In at least one embodiment of the present invention, this scenario is prevented by requiring encryption, signature and/or key verification of the core content, the authorizing website, the usage restrictions, and/or other related transmission. An electronic key may, for example, be included in the transmission of the digital content, may be previously known by the receiving device, may be installed by viewing software, etc.

The present invention also includes options for alternative distribution channels providing electronic content to an end consumer. In at least one embodiment of the invention, content is amassed by a service provider and distributed to various broadcast providers in the form of packages or bundles. The end user may then request digital video content from a broadcast provider, and access this content if the receiving device has a condition that is compliant with the rules and/or restrictions related to the core content. In this scenario, the rules and/or restrictions may be provided by any actor within the delivery chain, and the compliance of the end user may be determined based on a various combinations of these guidelines.

### DESCRIPTION OF DRAWINGS

The invention will be further understood from the following detailed description of a preferred embodiment, taken in conjunction with appended drawings, in which:

FIG. 1 is a representation of an existing system for Digital Transmission Content Protection over Internet Protocol.

FIG. 2A is a modular representation of a wireless communication device usable in conjunction with at least one embodiment of the present invention.

FIG. 2B is a functional representation of a wireless communication device usable in conjunction with at least one embodiment of the present invention.

FIG. 2C is a representation of various methods of providing geographic location for a wireless communication device usable in conjunction with at least one embodiment of the present invention.

FIG. 3 describes a basic transaction between sources for digital content and a receiving device in accordance with at least one embodiment of the present invention.

FIG. 4 describes a basic transaction between sources for digital content, a receiving device and an authorizing website in accordance with at least one embodiment of the present invention.

FIG. 5A describes an exemplary transaction between sources for digital content, a receiving device and an authorizing website in accordance with at least one embodiment of the present invention.

FIG. 5B discloses an operational flow chart corresponding to the exemplary transaction of FIG. 5A.

FIG. 5C discloses an exemplary operator interface relating to a transaction between an digital content provider, a receiving device and an authorizing website in accordance with at least one embodiment of the present invention.

FIG. 6A describes a further exemplary transaction between sources for digital content, a receiving device and an authorizing website in accordance with at least one embodiment of the present invention.

FIG. 6B discloses an operational flow chart corresponding to the exemplary transaction of FIG. 6A.

FIG. 7A discloses the addition of security provisions to an exemplary transaction between sources for digital content, a receiving device and an authorizing website in accordance with at least one embodiment of the present invention.

FIG. 7B discloses the addition of security provisions to an exemplary transaction between sources for digital content, a receiving device, a rendering device and an authorizing website in accordance with at least one embodiment of the present invention.

FIG. 8 discloses an exemplary distribution scheme in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

The present invention includes examples of specific transmission technologies such as DVB. However, the invention is applicable to any applicable wired or wireless transmission system utilized to transmit data to local or remote clients. These types of communication include, but are not limited to, wired Internet, Wireless Local Area Networking (WLAN), Ultra Wide Band Networking (UWB), or a Wireless Universal Serial Bus Networking (WUSB), Global System for Mobile Communication (GSM) Networks, General Packet Radio Service (GPRS) sessions, Universal Mobile Telecommunications System (UMTS) sessions and any other 3G or 4G mobile technologies.

I. Existing Systems

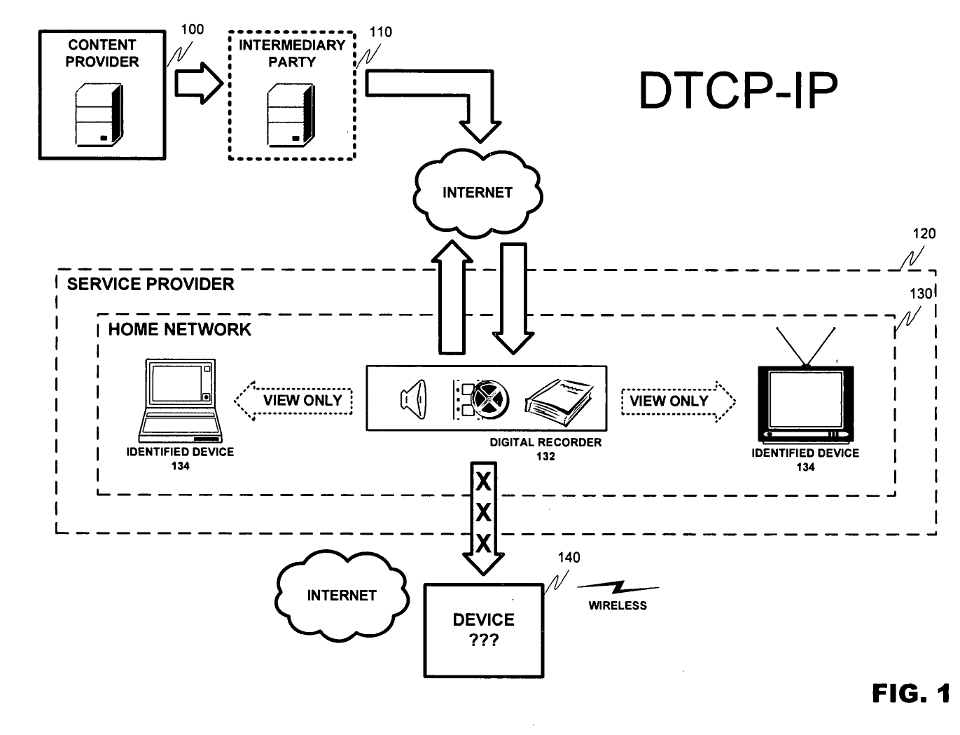

While more and more content items (e.g. television, movies, live performances, books, magazines, etc.) are being distributed electronically, the concept of controlling the rights of digital media is not a new concept. Over the last 15-20 years many groups have formulated systems and standards for enforcing copy protection for digital content. Most of these efforts had centered around preventing files from being copied from a physical media (e.g., floppy disk, compact disc (CD), CD-ROM, digital versatile disk (DVD), etc.) to a duplicable electronic form. Therefore, many of the copy protection methods have centered on electromechanical systems of identifying an original piece physical media and preventing information from being copied from the physical media. However, the popularity of purchasing digital content over the Internet has made physical media unnecessary. The theory of rights protection has evolved in an attempt to account for the changing marketplace. A method currently being implemented for usage guideline enforcement of purely digital distribution is shown in FIG. 1.

Digital Transmission Content Protection over Internet Protocol is a digital content protection system currently being implemented in the marketplace. According to FIG. 1, content provider 100 or an intermediary party 110 may provide digital content such as live video (streaming), previously recorded video, audio, games, data files containing text and pictures, etc. to various users. The intermediary party 110 may receive content from the content provider and specialize in the distribution aspect of the marketplace. These parties may collectively be known as the “source” of the content. The digital media is typically provided electronically via the Internet. Content is delivered by service provider 120 to home network 130. Service provider 120 may deliver the digital content directly from the source, or may concentrate or accumulate various files from different content providers or intermediary parties and distribute them as a package to the end user. DTCP works by determining the copy protection status of a file, and demanding an authentication key from the intended recipient. In the depicted example, communication occurs between the service provider and/or the source and a digital video recorder (DVR) 132 in the home network 130 of the user. According to the rules governing the distribution of the digital media, identification of a device, user identification, location, etc. may be queried before content may be downloaded from the source. The digital information may then be stored on DVR 132. In many situations, the digital content may have a “copy once” rule enforced, whereas the content may be broadcast (or “streamed”) to other identified devices 134 in the home network as authorized by the user, but the content is not stored locally on those devices. Most importantly, the content may not be sent anywhere outside the home network 130 via internet, wireless internet, etc. Unidentified device 140, connected via a remote link to the home network 130, may not access the protected content.

The limitations of the DTCP are substantial. As previously disclosed, digital content can only be downloaded and viewed from within the home network, controlled by limiting such parameters as the number of hops between routers, and the round-trip time. In many cases the content can only be saved once, eliminating the possibility of copying it to a portable device for later use outside the home. There is no way of designating mobile devices as permanent members of the home network, so that they could gain remote access to the content stored at home from outside the home. Therefore, this solution lacks any ability to deliver digital content to a device currently outside of a designated “home” geographic area.

II. Wireless Communication Device

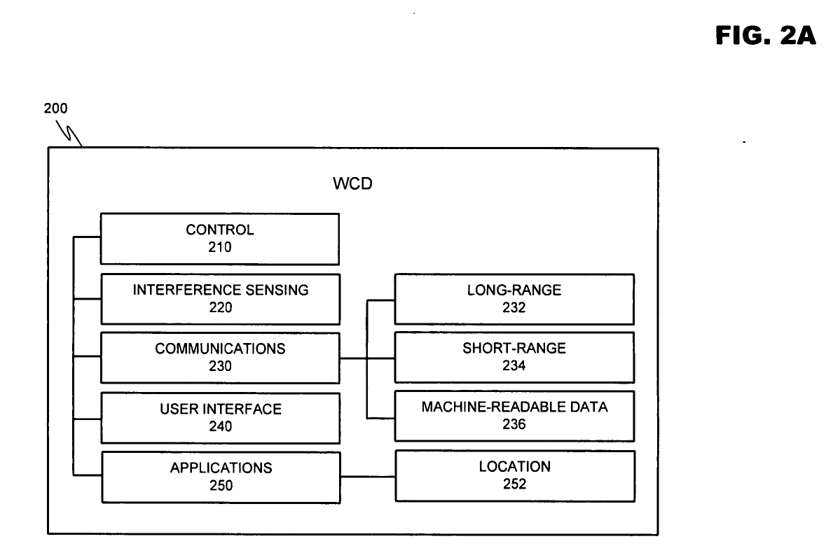

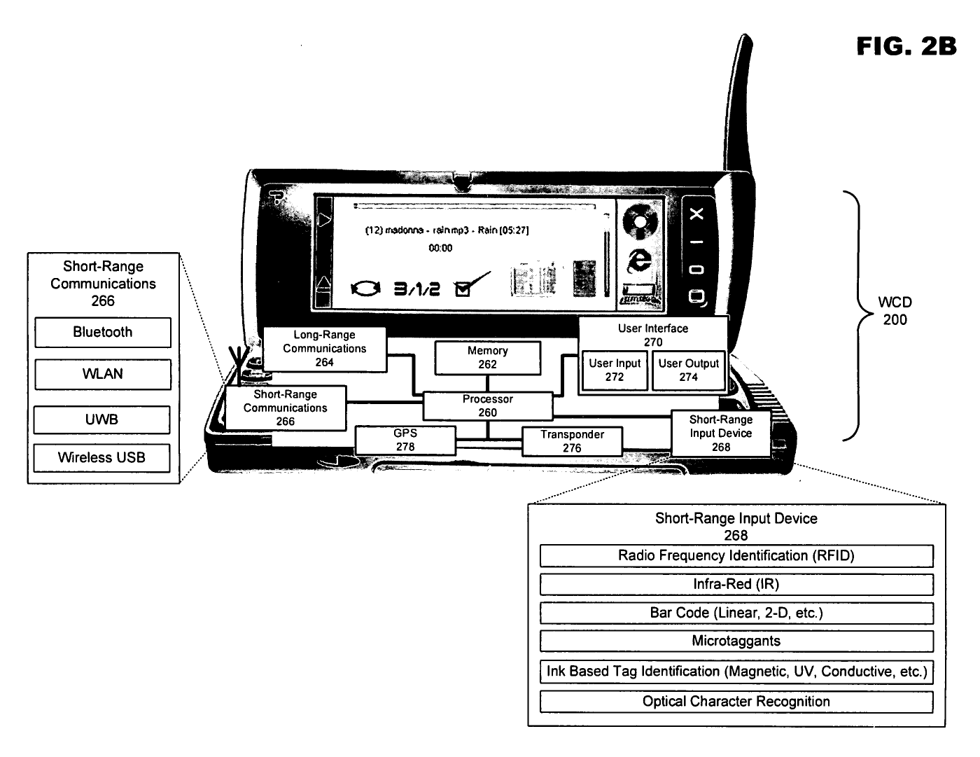

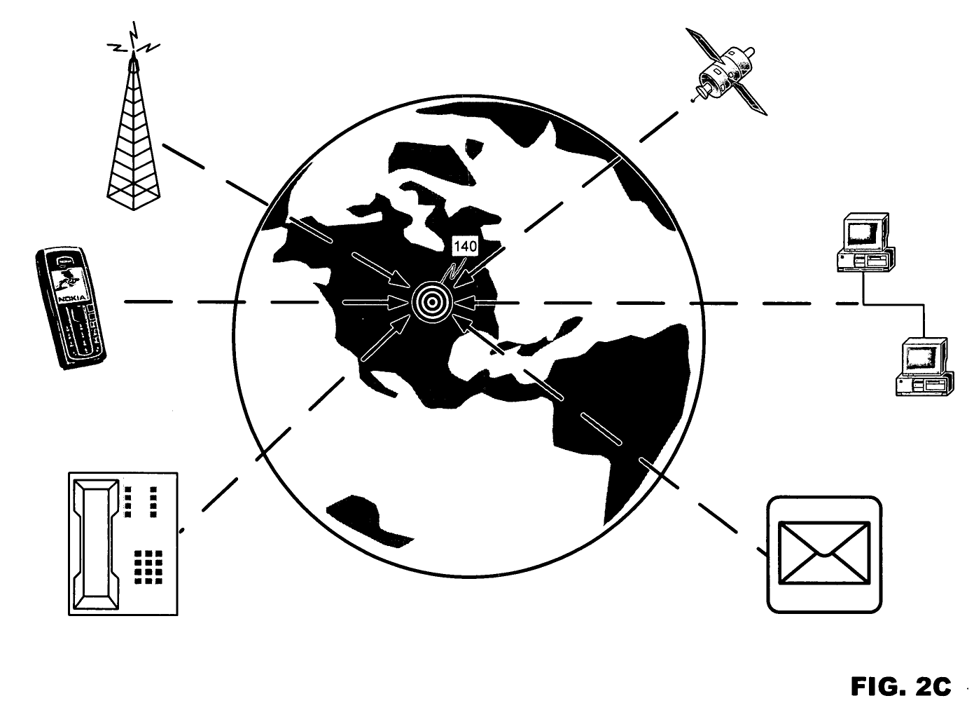

FIG. 2A discloses an exemplary modular layout for a handheld wireless communication device (WCD) 200 that a user, barring these limitations, would want to employ in receiving digital content. WCD 200 is part of a generic class of unidentified devices designated as device 140 in this disclosure. WCD 200 is broken down into modules representing the functional aspects of the device. These functions may be performed by the various combinations of software and/or hardware components discussed below.

Control module 210 regulates the operation of the device. Inputs may be received from various other modules included within WCD 200. For example, interference sensing module 220 may use various techniques known in the art to sense sources of environmental interference within the effective transmission range of the wireless communication device. Control module 210 interprets these data inputs and in response may issue control commands to the other modules in WCD 200.

Communications module 230 incorporates all of the communications aspects of WCD 200. As shown in FIG. 2A, communications module 230 includes for example long-range communications module 232, short-range communications module 234 and machine-readable data module 236. Communications module 230 utilizes at least these sub-modules to receive a multitude of different types of communication from both local and long distance sources, and to transmit data to recipient devices within the broadcast range of WCD 200. Communications module 230 may be triggered by control module 210 or by control resources local to the module responding to sensed messages, environmental influences and/or other devices in proximity to WCD 200. In at least one embodiment of the present invention, long-range communications module 232 may include a broadcast receiver utilizing e.g. DVB-H technology.

User interface module 240 includes visual, audible and tactile elements which allow the user of WCD 200 to receive data from, and enter data into, the device. The data entered by the user may be interpreted by control module 210 to affect the behavior of WCD 200. User inputted data may also be transmitted by communications module 230 to other devices within effective transmission range. Other devices in transmission range may also send information to WCD 200 via communications module 230, and control module 210 may cause this information to be transferred to user interface module 240 for presentment to the user.

Applications module 250 incorporates all other hardware and/or software applications on WCD 200. These applications may include sensors, interfaces, utilities, interpreters, data applications, etc., and may be invoked by control module 210 to read information provided by the various modules and in turn supply information to requesting modules in WCD 200. For example, location module 252 may be an application within application module 250, and may provide information regarding geographic location of WCD 200 to control module 210, or any other module within WCD 200 requesting this information.

FIG. 2B discloses an exemplary structural layout of WCD 200 according to an embodiment of the present invention that may be used to implement the functionality of the modular system previously described. Processor 260 controls overall device operation. As shown in FIG. 2B, processor 260 is coupled to communications sections 264, 266 and 268. Processor 260 may be implemented with one or more microprocessors that are each capable of executing software instructions stored in memory 262.

Memory 262 may include random access memory (RAM), read only memory (ROM), and/or flash memory, and stores information in the form of data and software components (also referred to herein as modules). The data stored by memory 262 may be associated with particular software components. In addition, this data may be associated with databases, such as a bookmark database or a business database for scheduling, email, etc. In one embodiment of the present invention, at least one of the memories receives content bursts via the broadcast receiver and discharges the content to other elements of WCD 200.

The software components stored by memory 262 include instructions that can be executed by processor 260. Various types of software components may be stored in memory 262. For instance, memory 262 may store software components that control the operation of communication sections 264, 266 and 268. Memory 262 may also store software components including a firewall, a service guide manager, a bookmark database, user interface manager, and any communications utilities modules required to support WCD 200.

Long-range communications 264 performs functions related to the exchange of information across large coverage area networks (such as cellular networks) via an antenna. Therefore, long-range communications 264 may operate to establish data communications sessions, such as General Packet Radio Service (GPRS) sessions and/or Universal Mobile Telecommunications System (UMTS) sessions. Also, long-range communications 264 may operate to transmit and receive messages, such as short messaging service (SMS) messages and/or multimedia messaging service (MMS) messages.

Short-range communications 266 is responsible for functions involving the exchange of information across short-range wireless networks. As described above and depicted in FIG. 2B, examples of such short-range communications 266 are not limited to Bluetooth™, WLAN, UWB and Wireless USB connections. Accordingly, short-range communications 266 performs functions related to the establishment of short-range connections, as well as processing related to the transmission and reception of information via such connections.

Short-range input device 268, also depicted in FIG. 2B, may provide functionality related to the short-range scanning of machine-readable data. For example, processor 260 may control short-range input device 268 to generate RF signals for activating an RFID transponder, and may in turn control the reception of signals from an RFID transponder. Other short-range scanning methods for reading machine-readable data that may be supported by the short-range input device 268 are not limited to IR communications, linear and 2-D bar code readers (including processes related to interpreting UPC labels), and optical character recognition devices for reading magnetic, UV, conductive or other types of coded data that may be provided in a tag using suitable ink. In order for the short-range input device 268 to scan the aforementioned types of machine-readable data, the input device may include optical detectors, magnetic detectors, CCDs or other sensors known in the art for interpreting machine-readable information.

Further shown in FIG. 2B, user interface 270 is also coupled to processor 260. User interface 270 facilitates the exchange of information with a user. FIG. 2B discloses that user interface 270 includes a user input 272 and a user output 274. User input 272 may include one or more components that allow a user to input information. Examples of such components include keypads, touch screens, and microphones. User output 274 allows a user to receive information from the device. Thus, user output portion 274 may include various components, such as a display, Light emitting diodes (LED), tactile emitters and one or more audio speakers. Exemplary displays include liquid crystal displays (LCDs), and other video displays.

WCD 200 may also include a transponder 276. This is essentially a passive device that may be programmed by processor 260 with information to be delivered in response to a scan from an outside source. For example, an RFID scanner mounted in a entryway may continuously emit radio frequency waves. When a person with a device containing transponder 276 walks through the door, the transponder is energized and may respond with information identifying the device, the person, etc.

Global Positioning System (GPS) 278 is an example of additional system that may be included in WCD 200 to provide geographical location information. GPS 278 may include components allowing WCD 200 to calculate its global coordinates based on signals sent from orbiting satellites or radio towers. This information may be used by processor 260 in conjunction with other applications, or be displayed by user interface 270 to inform a user of the current position of WCD 200.

Hardware corresponding to communications sections 264, 266 and 268 provide for the transmission and reception of signals. Accordingly, these portions may include components (e.g., electronics) that perform functions, such as modulation, demodulation, amplification, and filtering. These portions may be locally controlled, or controlled by processor 260 in accordance with software communications components stored in memory 262.

The elements shown in FIG. 2B may be constituted and coupled according to various techniques in order to produce the functionality described in FIG. 2A. One such technique involves coupling separate hardware components corresponding to processor 260, memory 262, communications sections 264 and 266, short-range input device 268, user interface 270, transponder 276, GPS 278, etc. through one or more bus interfaces. Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 270 may interact with a communications utilities software component, also contained in memory 262, which provides for the establishment of service sessions using long-range communications 264 and/or short-range communications 266. The communications utilities component may include various routines that allow the reception of services from remote devices according to mediums

III. Determination of Device Location

One key characteristic used to determine whether a device conforms to the rules and/or restrictions associated with protected content is the location of the device. As previously discussed, location-based screening may be used to both maintain a controlled release of digital video content to different regions, as an incentive to sell out tickets for certain live events, etc. Various methods for determining the location of device 140 are shown in FIG. 2C. For example, satellite location may be used to pinpoint location via GPS. Radio or cellular positioning systems may be able to determine the location of a device using the cellular ID number and the location of the last cellular system used by the device. More conventional location systems may also be employed, including determining the location of terrestrial access points. In these cases, a remote device may access a network via a wired connection, and their current location may determined by means such as a network address (e.g., IP address), phone number, zip code, country code, etc. These connections may be made by a person who, for example, is traveling and would like to access protected digital content using a temporary/provided device (e.g. a hotel television, telephone, computer or video system) or via their own personal handheld device connected to a foreign wired or wireless network.

The problem introduced by all of these systems is compatibility. A particular digital device 140 capable of receiving and accessing digital information may be able to use only one of these location-defining systems. These devices include items as simple as cell phones and as complex as desktop computers. Mapping between the different location-defining systems would be difficult, especially when transferring content between different types of devices over a remote connection. Ideally, any device requesting protected content must also have rule information related to the digital media supplied in a format that is compatible with the device. In this way, the device may determine if its current condition complies with the rules governing the use of the content, and may pattern its behavior in accordance with the usage rules.

IV. A Protection System Including Protection Information with the Core Transmission

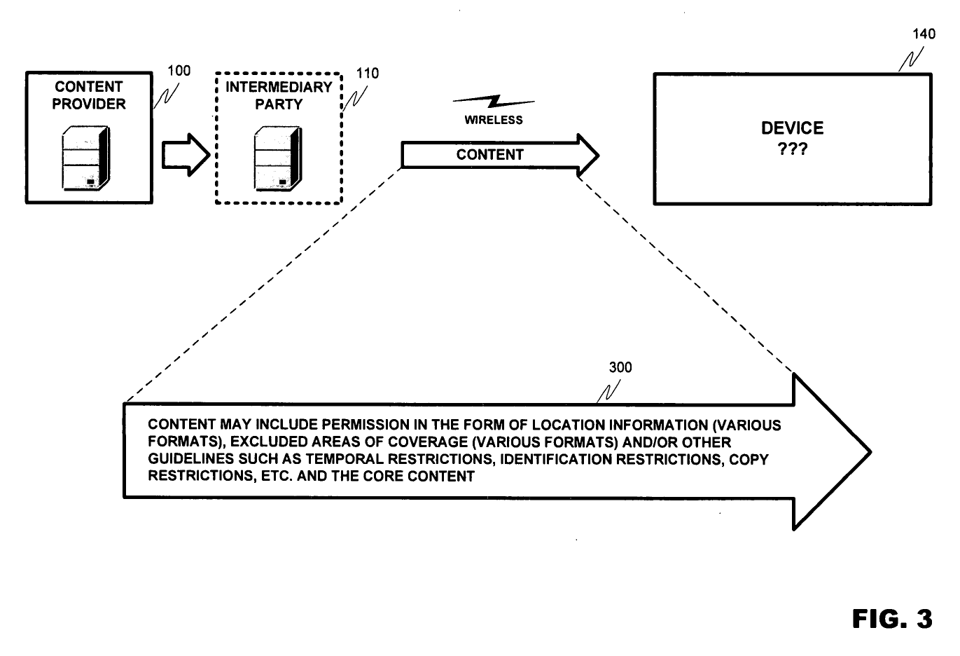

An exemplary method for implementing remote enforcement of copy protection for digital media is shown in FIG. 3. Device 140 is unidentified to content provider 100 and/or intermediary party 110, and may be operating from an unknown location. Protected content may be requested by device 140, or may be broadcast generally to digital devices from the source. In this case, the decision as to whether a receiving device 140 is compliant and may access the content is determined by the device itself.

Content 300, sent via wireless communication in this example, contains all permission information required to judge whether the receiving device 140 is in compliance with the rules governing use of the digital media. The permission information must account for a multitude of potential viewing devices. Therefore, the permission information necessarily includes location information for areas permitted to view the content (in various formats as previously described), information related to excluded areas of coverage ((in various formats as previously described), any other restrictions information such as temporal restrictions, identification restrictions, copying restrictions, etc. Depending on the situation, the permission information to be included with the signal may be substantial, and the content provider 100 or intermediary party 110 may not be able to communicate all of the restrictions put on the content, or alternatively, may not be able to put the permission information into all of the location-defining formats desired. For instance, bandwidth limitations (taking into account that the information needs to be repeated frequently to reduce initial access time for devices after switching them on, selecting a particular service, etc.) may prevent broadcasting the information in a multitude of different location-defining formats. Problems may also be seen in the receiving device 140 due to hardware limitations. A cellular phone may not have the processing capabilities or memory required to both download the content and the protection information so that the usage restrictions may be enforced in an efficient manner.

IV. Improvements Realized by the Present Invention.

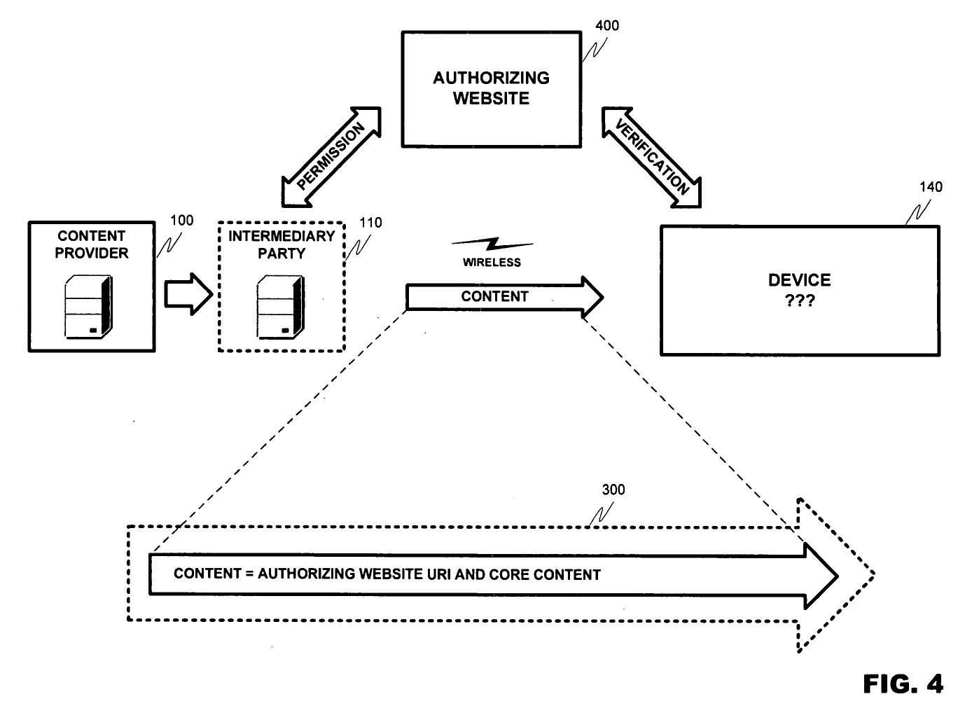

FIG. 4 introduces an embodiment of the present invention. Another actor is introduced into the transaction, authorizing website 400, to reallocate the burden of communicating the rules and/or restrictions related to the core content. Both the source of the digital content and the receiving device 140 interact with the website to both set the permissions and examine the permissions, respectively. The additional information required to be sent in the digital content signal 300 that is broadcast to all devices may then be greatly reduced. Instead of having to send the rights information out as part of the transmission with the core content, the rights information may be limited to a universal resource indicator (URI), of which a universal resource locator (URL), or website address, is a subset. The receiving device (or the rendering device if not the same as the receiving device) may use this information to contact the authorizing website. The website is a centralized repository of permission rules information, and may contain rules and/or restrictions related to a large amount of content. In addition, these rules and/or restrictions may be expressed in a variety of formats, allowing devices of different types to access and find compatible permission information.

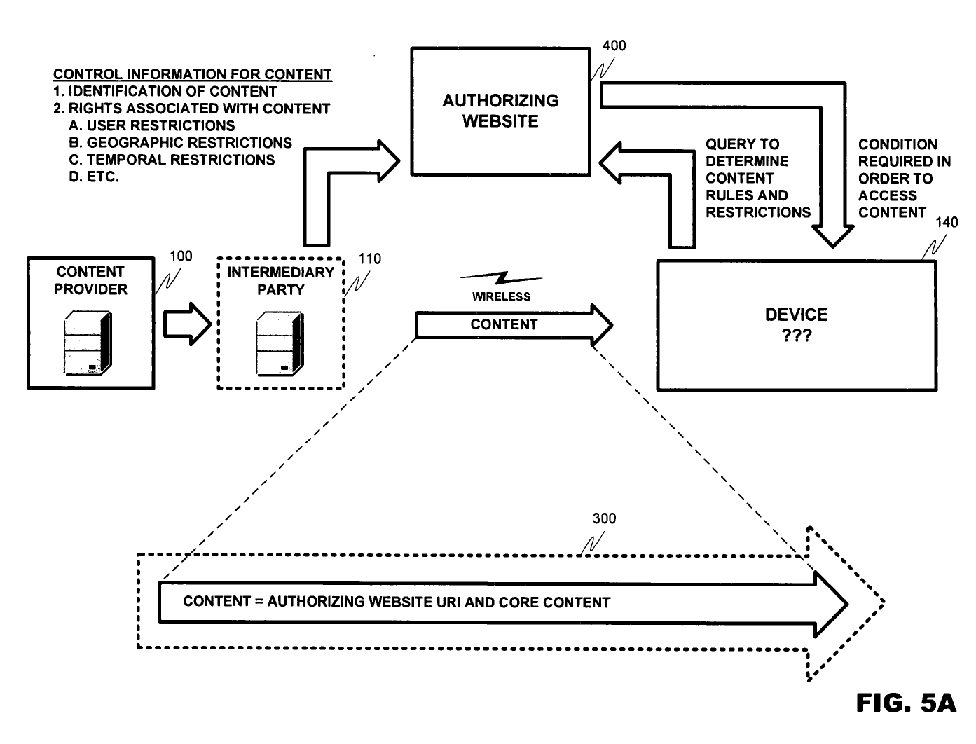

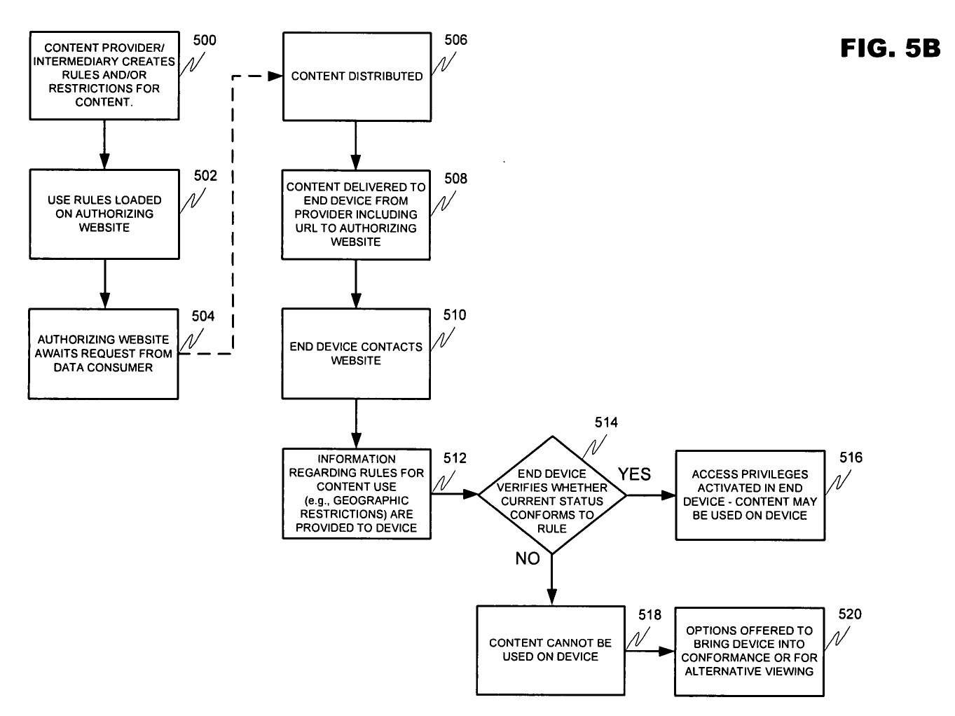

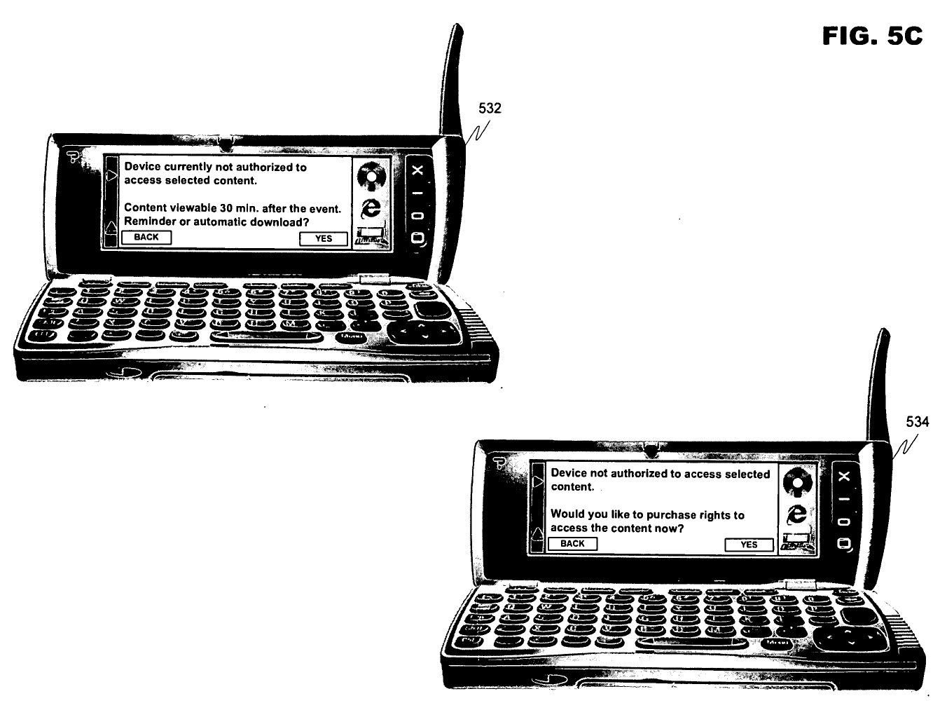

An exemplary embodiment of the present invention is disclosed more specifically in FIG. 5A. Content provider 100 and or intermediary party 110 defines the usage rules and restrictions for content 300 in authorizing website 400, and receiving device 140 both queries and receive feedback from authorizing website 400 with respect to rules and/or restrictions governing content 300. This process is further described in a flow chart disclosed in FIG. 5B. In step 500, the source of the content creates usage rules for controlling the use of content. The rules and/or restriction controlling the content may involve geographical limitations, temporal limitations, user/subscriber restrictions, copy restrictions, etc. These rules are then stored on the website 400 (step 502). The translation of these rules into formats compatible with various devices may be performed by the content provider, or may be performed after the basic rules are uploaded to the website. In step 504, the authorizing website 400 then enters a mode where it awaits contact from device 140.

Content distribution begins in step 506. The content may be automatically broadcast from content provider 100 or intermediary party 110. Alternatively, the user may request content using a service manager or other operator interface located on device 140. At step 508, the content, including URI information for authorizing website 400 and the core content, is delivered to device 140. The device then contacts the website in step 510. This communication may occur after the content has been fully downloaded and stored in a locked state, or may be contacted simultaneously to the download if the device is capable of managing multiple simultaneous connections.

In step 512, device 140 accesses the rules and/or restriction information related to content 300. Device 140 may retrieve usage permissions and/or restrictions by selecting a compatible type of geographic identifier, or may identify itself by mfg., model number, etc. so that the website may provide the appropriate compatibility information. This may be done, for example, by appending a device or format identifier to the URI received with the content 300. The information retrieved by device 140 allows it to determine whether, given the current conditions of the device (e.g., location), the device may comply with the digital media usage requirements (step 514). If device 140 is in compliance, the user is granted access to content 300 in step 516, e.g. when the broadcast of the program is next occurs according to the schedule. On the other hand, if device 140 is not in compliance, then access is denied in step 518.

However, this denial may not end the transaction. Step 520 may be implemented in some embodiments of the invention in order to provide a solution that will place device 140 in compliant state. FIG. 5C shows two exemplary user interface output screens offering options to the user to perform actions that will put the device in compliance. Example 532 discloses a situation where a user has attempted to access digital video media of a live event. The display has advised the user that the content is not currently available, however, the content will become available thirty (30) minutes after the conclusion of the event. An option is also given to have the device remind the user when the content becomes available, or to automatically download the content when it becomes available. Presumably device 140 would then present another interface display allowing the user to configure the desired function. In another example 534, the user has attempted to access content to which rights are not currently granted. However, the option does exist for the unit to become compliant if the user purchases access rights to the content. This purchase may be a subscription to a service provided by the content provider or an intermediary party. Upon selecting “YES” in the display shown at 534, the user would be taken to another display allowing subscription information to be entered, which may subsequently be communicated via long range communications such as GPRS, SMS, etc. to the source of the content.

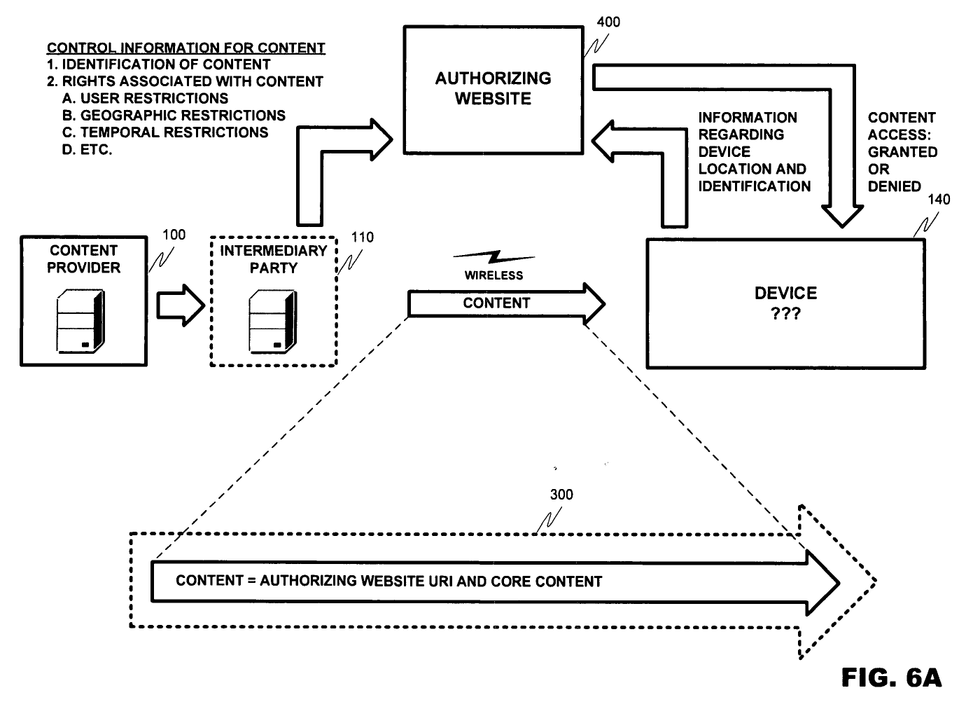

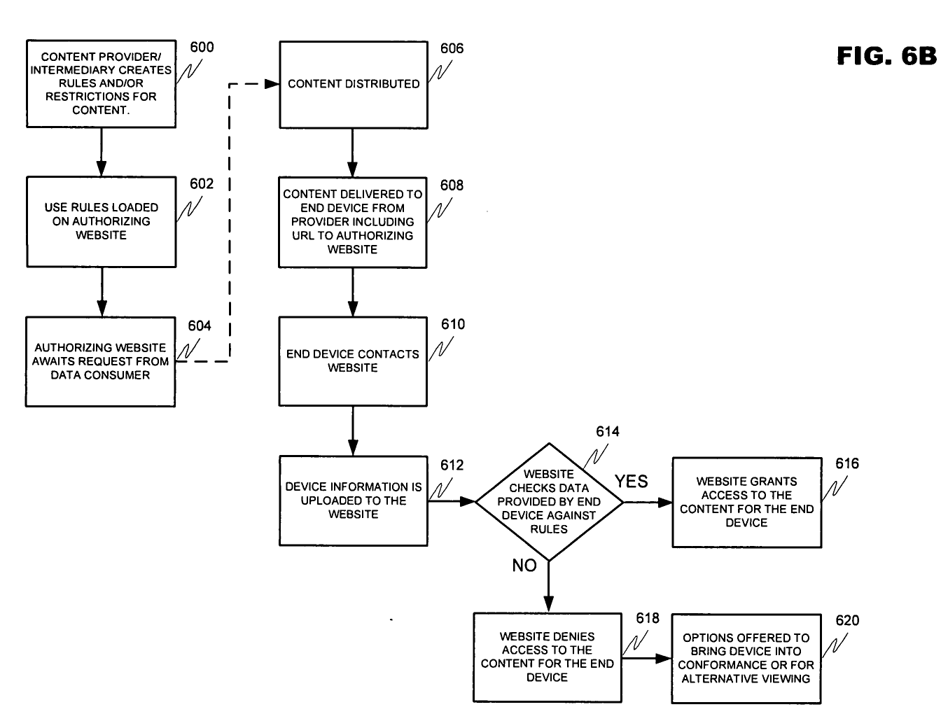

Another embodiment of the instant invention is shown in FIG. 6A. All the same participants are interacting to deliver protected digital content 300 to device 140, however, the interaction as described in the process flow of FIG. 6B differs from the previous embodiments in the steps involved between authorizing website 400 and device 140.

The steps are similar between the flowcharts of FIG. 5A and FIG. 6A until step 612. After device 140 has contacted authorizing website 400, the device uploads its current condition to the website. The current condition of the device may include a device identification, user identification, device manufacturer, device model number, device location, etc. This information is translated by the authorizing website into a format that may be compared to the rules and/or restrictions governing the content 300 (step 614). The website may then simply reply with a code that either grants access to the content 300 (step 616) or denies access to the content in step 618. Similar to the process of FIG. 5B, step 620 may be implemented to offer alternatives actions to the user to put the device in a state conforming to the rules and/or restrictions governing content 300.

V. Security Features Preventing Redirection and False Identification

A liability involved in using a remote website to authorize access to protected content is outside interference by actors with malicious intentions. In at least one example, a person seeking to by-pass geographical restrictions or copy protection rules and/or restrictions, such as a computer hacker, may attempt to redirect device 140 from authorizing website 400 to an entirely different website. This redirection would not be apparent to the user because there typically are no visual aspects to the authorizing process. The alternative website may give incorrect information to device 140 in order to cause it to malfunction. For example, a “fake” authorizing site may provide information approving every device for every digital media file, rendering the copy protection of the content ineffective.

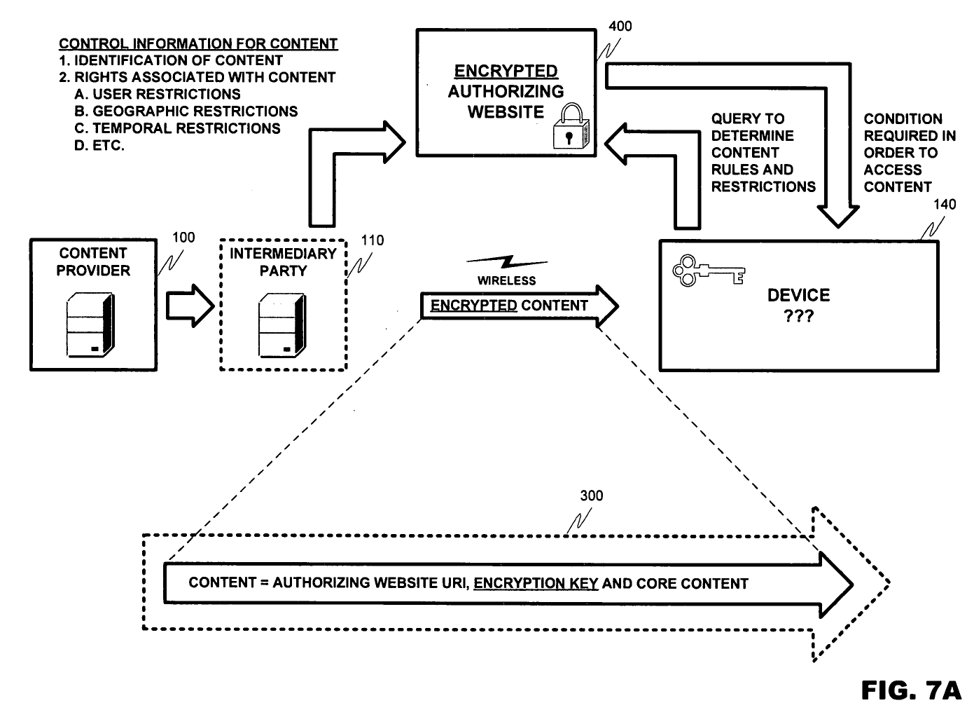

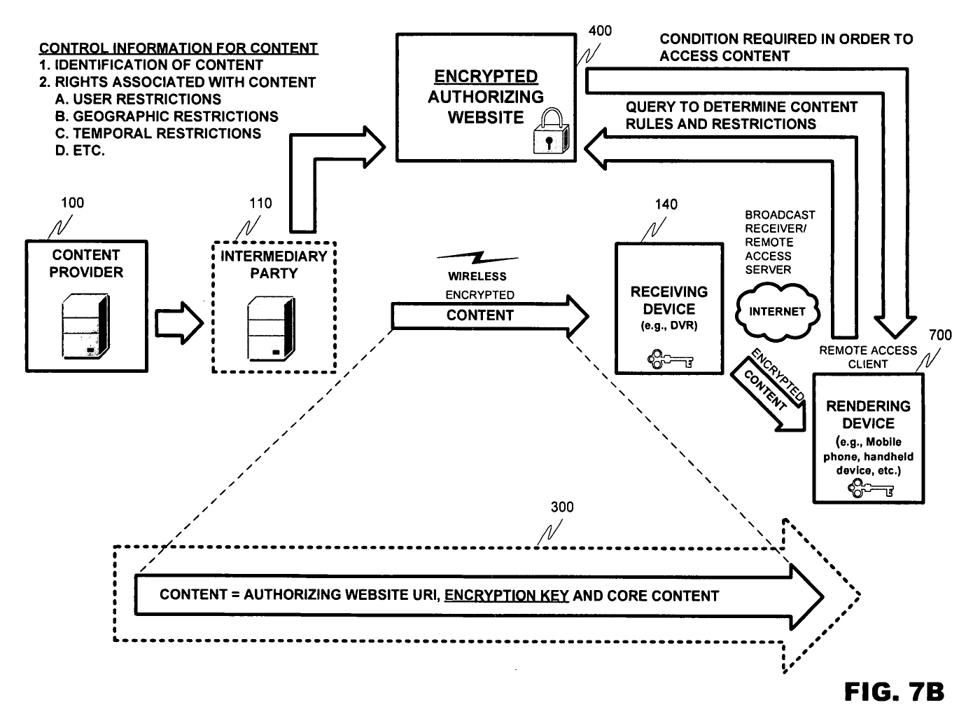

FIG. 7A includes features in an embodiment of the present invention to help circumvent the possibility of a malicious attack such as redirection. A number of different elements of the content delivery system may be encrypted or secured, and in this way, the redirection of a device to another site is made much more difficult.

In one example, content 300 may be encrypted so that the identity of the authorizing website 400 it must first be decrypted on device 140 in order to gain access. The authorizing website in this case may also be encrypted, or may be validated with a signature or an encryption key. The key may be provided to device 140 in digital content 300, may be known to all devices 140 of a certain type as a part of their original programming, may be obtained as separate data downloaded to the device (such as in the download of a particular video viewer or software package), etc. Before data is sent to authorizing website 400, an authentication process may occur in order to determine that the website contacted is the correct website. Further, any data sent from the authorizing website may be concatenated with signature data and may be hashed before being sent to device 140. To prevent the attacker from substituting data from another valid authorizing website that has a less restrictive policy, or from redirecting the query to such a website, the data may also include the URI. The device 140 checks that this URI matches the one that it used to access the authorizing website 400. Overall, any authorization to access protected content may first be authenticated by device 140 before access is granted to the content.

In another example of the present invention, the device receiving and storing the content and the device rendering the content to the user may in actuality be different devices. As shown in FIG. 7B, the receiving device 140 may, for instance, be a DVR located in a user's home network. The rendering device 700 may be a remote device the user has on their person, such as a cell phone, PDA, palmtop, handheld computer, laptop computer, etc. The content may be originally downloaded and stored on the DVR. However, despite the fact that the user is not presently at home, they may still want to access the content stored on the DVR. Provisions currently exist to allow a remote access client to communicate with a device in a home network over the Internet, for example, via a broadcast receiver or a remote access server. However, this transaction would be difficult using traditional rights protection. Multiple protection schemes and/or format information would be necessary to account for the device on the home network and the subsequent transfer to the remote access client. The DVR may utilize a geographic coding scheme totally incompatible with that of the rendering device. The large amount of information required to support such a protection scheme would be cumbersome, and a simple request to access content can quickly evolve into a complicated transaction.

These problems may be eliminated using the present invention. Every device involved in the transaction may use information included in the content to access authorizing website 400. The website includes rules and/or restriction information for a multitude of different types of devices. Therefore, the protection scheme may be implemented in the same way in each device, and each device may contact the website in order to determine whether its current condition will allow for accessing the content. This is shown in FIG. 7B, wherein rendering device 700 receives content 300 from receiving device 140. Rendering device 700 then accesses authorizing website 400 in order to determine rules and/or restrictions related to content 300. Further, FIG. 7B includes encryption features that may protect the transmission of the content during each phase of the transaction. Every device along the chain may include keys or signatures used to access and/or authorize information related to the content.

The key used to verify and/or gain access to authorizing website 400 or to authenticate content information may be a variable code. Formulas based on time, location, user or device ID, etc. may be used to compile a key to authenticate and/or access authorizing website 400. Further, any data on authorizing website 400 may be updated periodically by content provider 100 or intermediary party 110. The access rules and/or restrictions may be changed, for example, based on the age of the file. Access codes or keys may also be updated and periodically sent to users who use a certain type of software, members of a particular service, etc.

VI. System Topography

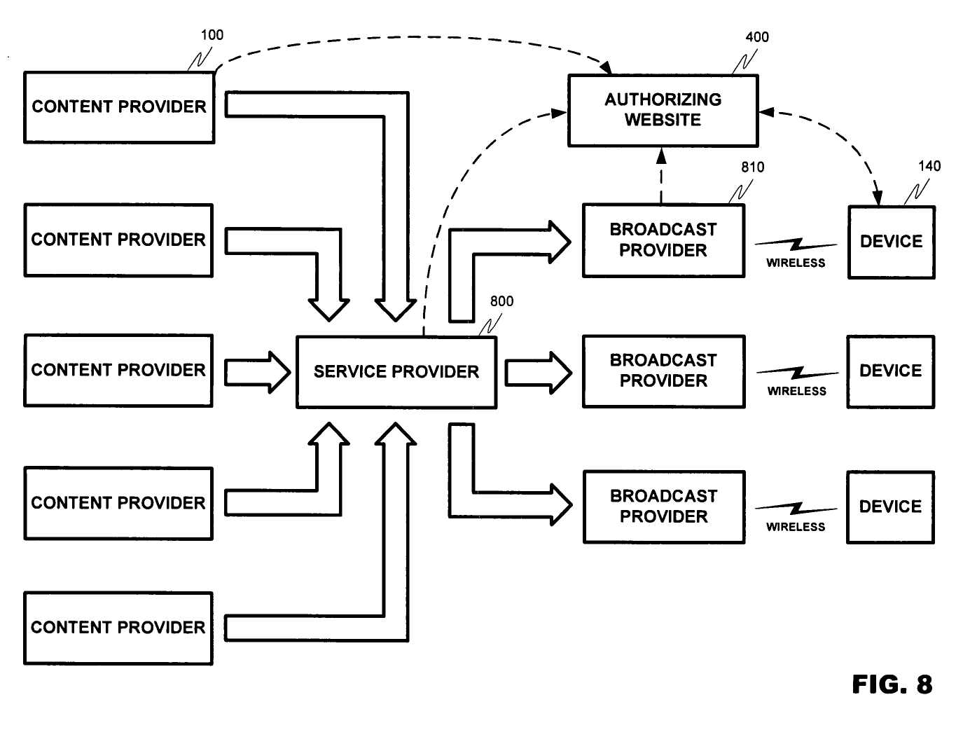

The basic system of the present invention may be employed to operate a much larger scale enterprise than disclosed in the previous examples. FIG. 8 is an exemplary layout for a high volume data delivery system wherein the intermediary parties 110 are now defined in more detail.

In the realm of business, content providers may be primarily focused on creating content, and therefore, may not desire to also manage the distribution of their content. The content providers in FIG. 8 may make their content available to service provider 800. Service provider 800 may have the ability to consolidate various types of content into packages, channels, bundles, etc. tailored for mass distribution to end users interested in a particular subject matter. These packages may be made available directly to the end data consumer, or may be distributed through entities that specialize in broadcasting the offerings of various service providers 800 to the end user. Broadcast provider 810 takes the compiled content of service provider 800 and makes it available to various devices 140. The owners of these devices may then choose the specific content they want to access from an abundance of compiled content.

Content providers 100, service providers 800, broadcast providers 810 and devices 140 all may access authorizing website 400. Each party forwarding digital media to an end consumer may configure the protection rules of specific content within the website. For example, the content provider may require that the content cannot be copied, while the service provider may determine that the content may not be viewed by someone not subscribed to the service. The broadcast provider may further determine certain geographical limits for viewing the data. These geographical limits may be established by contractual agreements with other broadcast providers. The user may then be subject to any or all of these requirements depending on the configuration of authorizing website 400 and device 140. In at least one case, device 140 may not access the protected content unless the device complies with all of the various providers rules and/or restrictions. Alternatively, there may be a hierarchy that allows less essential rules to be broken if certain conditions are fulfilled. The exact rule structure may ultimately depend on the parties involved in the transaction and the contractual agreements between them.

The present invention is an improvement over conventional rights protection systems because it allows usage permissions and/or restrictions for accessing digital media to be conveyed to a device residing anywhere in the world without adding substantial overhead to the content distribution. The system further provides flexibility in allowing a multitude of devices to access protected content regardless of manufacturer, model, technology, etc. The present invention maintains both an effective and efficient system that may be enhanced with security features to further prevent the digital rights from being overcome. In addition, devices that do not comply with rules and/or regulations governing certain media may be brought into compliance, expanding the ability of media providers to expediently deliver their content to the end data consumer.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

What is claimed is:

1. A method for controlling digital media usage in a device, comprising:
associating digital media with URI information;
receiving the digital media in a device via electronic transmission;
communicating with an authorizing website using the URI information;
accessing rules and/or restrictions information on the authorizing website related to the digital media; and
permitting access to the digital media if the device is in a condition that complies with the rules and/or restrictions information.

2. The method of claim 1, wherein the device receives the digital media via electronic transmission from another device that previously received and stored the digital media.

3. The method of claim 1, wherein the URI information is the same for all content coming from a distribution source, the distribution source including at least a broadcast service.

4. The method of claim 1, wherein the URI information includes an identifier for specific content.

5. The method of claim 1, wherein the device receives the digital media via a wired network.

6. The method of claim 1, wherein the device receives the digital media via wireless communication.

7. The method of claim 1, wherein the digital media is received as part of a general broadcast.

8. The method of claim 1, wherein the digital media is received in response to a request from the device.

9. The method of claim 1, wherein at least one of the digital media or the authorizing website is encrypted.

10. The method of claim 1, wherein at least one of the digital media or the device includes an authentication key.

11. The method of claim 10, wherein the authentication key is delivered to the device through a broadcast including the digital media.

12. The method of claim 1, wherein information stored on the authorizing website is protected with a digital signature, and at least one of the digital media, including any metadata associated with it, or the device includes an authentication key.

13. The method of claim 1, wherein the rules and/or restrictions information includes at least one of geographic restrictions, temporal restrictions, identification restrictions or copy restrictions limiting the use of the digital media.

14. The method of claim 13, wherein the geographic restrictions are stored on the authorizing website in a variety of different formats including at least one of global positioning system (GPS) information, radio location information, cellular location information, network location information, telephone area code information, country code information and zip code information.

15. The method of claim 13, wherein the device selects the format of the geographic restriction from the variety of different formats by indicating a preferred format when accessing the authorizing website.

16. The method of claim 1, wherein the rules and/or restrictions information on the authorizing website change over time.

17. The method of claim 1, wherein the rules and/or restrictions information is configured on the authorizing website by a distribution source of the digital media.

18. The method of claim 17, wherein additional rules and/or restrictions information may be configured on the authorizing website by an intermediary party.

19. The method of claim 1, wherein the determination as to whether the device is in a condition that complies with the rules and/or restrictions information is made by the device.

20. The method of claim 1, wherein the determination as to whether the device is in a condition that complies with the rules and/or restrictions information is made by the authorizing website.

21. The method of claim 1, further comprising:
providing, when the device is not in a condition that complies with the rules and/or restrictions information, options to a user of the device to pursue actions that will put the device in a compliant condition.

22. A device capable of accessing digital media, comprising:
reception logic for receiving digital media via electronic transmission, the digital media being associated with URI information;
communication logic for accessing an authorizing website, using the URI information, to retrieve rules and/or restrictions information related to the digital media; and
control logic for permitting access to the digital media if the device is in a condition that complies with the rules and/or restrictions information.

23. The device of claim 22, wherein the device receives the digital media via electronic transmission from another device that previously received and stored the digital media.

24. The device of claim 22, wherein the URI information is the same for all content coming from a distribution source, the distribution source including at least a broadcast service.

25. The device of claim 22, wherein the URI information includes an identifier for specific content.

26. The device of claim 22, wherein the device receives the digital media via a wired network.

27. The device of claim 22, wherein the device receives the digital media via wireless communication.

28. The device of claim 22, wherein the digital media is received as part of a general broadcast.

29. The device of claim 22, wherein the digital media is received in response to a request from the device.

30. The device of claim 22, wherein at least one of the digital media or the authorizing website is encrypted.

31. The device of claim 22, wherein at least one of the digital media or the device includes an authentication key.

32. The device of claim 31, wherein the authentication key is delivered to the device through a broadcast including the digital media.

33. The device of claim 22, wherein information stored on the authorizing website is protected with a digital signature, and at least one of the digital media, including any metadata associated with it, or the device includes an authentication key.

34. The device of claim 22, wherein the rules and/or restrictions information includes at least one of geographic restrictions, temporal restrictions, identification restrictions or copy restrictions limiting the use of the digital media.

35. The device of claim 34, wherein the geographic restrictions are stored on the authorizing website in a variety of different formats including at least one of global positioning system (GPS) information, radio location information, cellular location information, network location information, telephone area code information, country code information and zip code information.

36. The device of claim 34, wherein the device selects the format of the geographic restriction from the variety of different formats by indicating a preferred format when accessing the authorizing website.

37. The device of claim 22, wherein the rules and/or restrictions information on the authorizing website change over time.

38. The device of claim 22, wherein the rules and/or restrictions information is configured on the authorizing website by a distribution source of the digital media.

39. The device of claim 38, wherein additional rules and/or restrictions information may be configured on the authorizing website by an intermediary party.

40. The device of claim 22, wherein the determination as to whether the device is in a condition that complies with the rules and/or restrictions information is made by the device.

41. The device of claim 22, wherein the determination as to whether the device is in a condition that complies with the rules and/or restrictions information is made by the authorizing website.

42. The device of claim 22, further comprising:
control logic for providing, when the device is not in a condition that complies with the rules and/or restrictions information, options to a user of the device to pursue actions that will put the device in a compliant condition.

43. A computer program product comprising a computer usable medium having computer readable program code embodied in said medium for controlling digital media usage in a device, comprising:
a computer readable program code for associating digital media with URI information;
a computer readable program code for receiving the digital media in a device via electronic transmission;
a computer readable program code for communicating with an authorizing website using the URI information;
a computer readable program code for accessing rules and/or restrictions information on the authorizing website related to the digital media; and
a computer readable program code for permitting access to the digital media if the device is in a condition that complies with the rules and/or restrictions information.

44. The computer program product of claim 43, wherein the device receives the digital media via electronic transmission from another device that previously received and stored the digital media.

45. The computer program product of claim 43, wherein the URI information is the same for all content coming from a distribution source, the distribution source including at least a broadcast service.

46. The computer program product of claim 43, wherein the URI information includes an identifier for specific content.

47. The computer program product of claim 43, wherein the device receives the digital media via a wired network.

48. The computer program product of claim 43, wherein the device receives the digital media via wireless communication.

49. The computer program product of claim 43, wherein the digital media is received as part of a general broadcast.

50. The computer program product of claim 43, wherein the digital media is received in response to a request from the device.

51. The computer program product of claim 43, wherein at least one of the digital media or the authorizing website is encrypted.

52. The computer program product of claim 43, wherein at least one of the digital media or the device includes an authentication key.

53. The computer program product of claim 52, wherein the authentication key is delivered to the device through a broadcast including the digital media.

54. The computer program product of claim 43, wherein information stored on the authorizing web site is protected with a digital signature, and at least one of the digital media, including any metadata associated with it, or the device includes an authentication key.

55. The computer program product of claim 43, wherein the rules and/or restrictions information includes at least one of geographic restrictions, temporal restrictions, identification restrictions or copy restrictions limiting the use of the digital media.

56. The computer program product of claim 55, wherein the geographic restrictions are stored on the authorizing website in a variety of different formats including at least one of global positioning system (GPS) information, radio location information, cellular location information, network location information, telephone area code information, country code information and zip code information.

57. The computer program product of claim 55, wherein the device selects the format of the geographic restriction from the variety of different formats by indicating a preferred format when accessing the authorizing website.

58. The computer program product of claim 43, wherein the rules and/or restrictions information on the authorizing website change over time.

59. The computer program product of claim 43, wherein the rules and/or restrictions information is configured on the authorizing website by a distribution source of the digital media.

60. The computer program product of claim 59, wherein additional rules and/or restrictions information may be configured on the authorizing website by an intermediary party.

61. The computer program product of claim 43, wherein the determination as to whether the device is in a condition that complies with the rules and/or restrictions information is made by the device.

62. The computer program product of claim 43, wherein the determination as to whether the device is in a condition that complies with the rules and/or restrictions information is made by the authorizing website.

63. The computer program product of claim 43, further comprising:
providing, when the device is not in a condition that complies with the rules and/or restrictions information, options to a user of the device to pursue actions that will put the device in a compliant condition.

64. A system for delivering digital media to a device, comprising:
a source node;
a device;
an authorizing website
a source node associating digital media with URI information;
the device receiving the digital media via electronic transmission;
the device using the URI information to communicate with the authorizing website; wherein the device accesses rules and/or restrictions information on the authorizing website regarding the digital media; and
as a result of the device accessing the authorizing website, the device permitting access to the digital media if the device is in a condition that complies with the rules and/or restrictions information.
